(19) United States
(12) Patent Application Publication
(10) Pub. No.: US 2026/0155702 A1
(43) Pub. Date: Jun. 4, 2026

(54) Sealed Stator Termination For Direct Cooled E-Motors

(71) Applicant: Garrett Transportation I Inc., Torrance, CA (US)

(72) Inventors: Srinidhi P R, Chikkaballapur (IN); Gagan Kashyap K M, Kunigal (IN); Kishor Kumar K, Bangalore (IN); Praveen Kumar A, Bangalore (IN)

(73) Assignee: Garrett Transportation I Inc., Torrance, CA (US)

(21) Appl. No.: 19/055,754

(22) Filed: Feb. 18, 2025

(30) Foreign Application Priority Data
Dec. 4, 2024 (IN) 202411095414

(51) Int. Cl. H02K 5/22

(52) U.S. Cl. CPC H02K 5/225

(57) ABSTRACT

A connector block for a stator housing is disclosed. The connector block includes a housing forming an open cavity that has first and second access openings and a grommet arranged in the first access opening to seal access into the cavity via the first access opening. A seal having a first surface facing out from the cavity and a second surface facing into the cavity is also included. The seal is arranged in the second access opening to seal access into the cavity via the second access opening. A steel plate is arranged on the second surface of the seal. A terminal is arranged within the cavity. The terminal includes a first opening arranged to receive any connector passing through the grommet and at least one wire crimping element arranged to receive crimping ends of wire or wires passing through the second access opening.

### BACKGROUND OF THE INVENTION

### Field of the Invention

The presently disclosed invention relates to terminal housings or connector blocks of stators for application within: electric motors, direct cooled electric motors; heating ventilation, and air conditioning systems (HVAC); and the like.

### Description of Related Art

A direct-cooled e-motor is an electric motor in which the heat generated within the motor components is directly dissipated using a cooling medium, such as water or oil, which flows directly over critical parts like the stator or rotor. This cooling approach enhances efficiency by preventing overheating, allowing the motor to handle higher power outputs without risk of thermal degradation.

HVAC refers to the systems used to regulate interior and/or indoor environmental conditions by providing heating, cooling, and ventilation in buildings, vehicles and the like. These systems are essential for maintaining comfortable indoor temperatures, managing humidity levels, and ensuring good air quality by circulating and filtering air. HVAC systems are used in residential, commercial, and industrial settings to support both occupant comfort and equipment functionality. While the present invention will be discussed within the context of directly cooled electric motors, while other applications of the present invention, such as within HVAC systems, is understood by the skilled person to be included herewith.

The stator in an electric motor (e-motor) plays a crucial role, as it contains the stationary windings through which an electric current flows, creating a magnetic field. This magnetic field interacts with the rotor to generate torque, thereby producing the rotational force necessary for motor operation. In direct-cooled designs, the stator's cooling is particularly important, as it helps maintain optimal operating temperatures, increases motor lifespan, and ensures consistent performance, especially under high-load and/or prolonged use conditions.

The key components of a stator in a direct-cooled e-motor include a lamination stack, windings, cooling channels, insulating material and a housing. The lamination stack comprises thin steel laminations stacked together to form the core of the stator, thereby helping to guide the magnetic field efficiently while minimizing energy loss from eddy currents. The windings comprise copper or aluminum windings wrapped around the lamination stack to create the magnetic field when current flows through them. In direct-cooled designs, the windings are often insulated with materials that withstand direct exposure to coolant. The cooling channels are embedded within or around the stator core and carry a coolant, often water or oil, to directly dissipate heat generated by the windings and core, thereby enhancing thermal management. The insulation material coats the windings to protect against electrical faults and withstand exposure to coolant, which is crucial for maintaining the motor's durability. The housing provides structural support and sometimes incorporates additional cooling jackets for enhanced thermal control. Together, these components enable efficient operation by controlling heat build-up, ensuring stable performance even under high loads.

In a direct-cooled e-motor, the connector block of the stator serves as the interface between the stator windings and external power or control systems. It provides a secure and electrically stable connection point for current to enter the stator windings, enabling the creation of the electromagnetic fields necessary for motor operation. Additionally, it helps organize and route the electrical connections within the motor, protecting them from environmental factors and mechanical stress, which is particularly important in direct-cooled systems where exposure to coolants is common. In essence, the connector block ensures a reliable power supply to the stator, supporting efficient motor performance while minimizing electrical losses or faults due to unstable connections.

In direct-cooled e-motors, which rely on direct cooling of internal components like the stator to manage heat, connector blocks play a crucial role in maintaining efficient and effective electrical pathways. Connector blocks provide stable connections between the stator's windings and the power source or control system. However, due to the demands of direct-cooling systems and high-performance environments, these blocks face numerous challenges, including corrosion and coolant ingress, thermal expansion stress and fatigue, electrical arcing, vibration induced loosening, and insulation breakdown.

One of the primary challenges faced by connector blocks in direct-cooled e-motors is corrosion due to exposure to coolant, whether water or oil. While direct cooling is efficient for heat management, it can create an environment where electrical components are susceptible to corrosion, especially if they are in prolonged contact with coolant or if the seals are inadequate. Coolant ingress can lead to electrical short circuits and damage to the connectors due to corrosion. Even when corrosion-resistant materials are used, certain coolants can penetrate seals or react with other materials over time, leading to gradual degradation of connectors. Certain solutions have been proposed in the art, including use of corrosion-resistant materials such as stainless steel or specially coated metals that can increase the resistance of connectors to corrosion; enhanced sealing techniques including improved seal designs, such as double-layer seals or gaskets made from high-performance polymers to effectively prevent coolant ingress effectively; and selective use of non-conductive coolants like specific dielectric oils that can reduce the risk of electrical short circuits while still providing effective cooling.

Regarding thermal expansion and material fatigue, e-motors generate significant heat during operation, which is managed through direct cooling. However, this cooling can lead to cyclic thermal expansion and contraction of materials, causing fatigue and eventual failure of the connector blocks. When materials expand and contract repeatedly, they can experience stress, causing cracks, loosening connections, and overall degradation over time. Thermal fatigue is especially a concern when materials with different expansion coefficients are used together, as they will expand and contract at different rates. Solutions proposed in the art include use of materials with low thermal expansion including specific metal alloys that exhibit minimal thermal expansion that can reduce the impact of thermal cycles; flexible connection designs that can help absorb the stress from expansion and contraction, reducing the likelihood of loosening or cracking; and thermally stable insulation materials that can withstands high temperatures and cycles well without degrading as degraded insulation can increase the risk of short circuits.

Electrical arcing arises from imperfect connections or fluctuating currents that can lead to arcing, which damages contacts and degrades connection reliability and otherwise occurs when there is an unstable connection, leading to sparks that can damage the connector's contacts over time. In a direct-cooled e-motor, where connections must carry high current levels, even slight fluctuations or imperfections in contact can lead to arcing. Arcing generates heat and erodes contacts, weakening the overall connection and potentially leading to failure. In severe cases, arcing can damage the surrounding insulation and create a risk of short circuits or fire. Proposed solutions in the art include use of high-quality conductive materials like copper with high conductivity and wear resistance that can reduce the chance of arcing by ensuring stable and consistent contact; designing connectors with tight, self-locking mechanisms that can help maintain stable contact, even under conditions of vibration or thermal expansion; along with routine checking that can identify early signs of wear or arcing and allow for preventative measures, thereby reducing the need for more extensive repairs later on.

Electric motors, especially those used in automotive applications, are exposed to constant vibration. Vibration-induced loosening is a major concern for connector blocks, as it can result in the gradual loosening of bolts, screws, and other connectors. When components loosen, the electrical connection may weaken, thereby increasing the likelihood of arcing, interruptions, or even complete disconnections. This can significantly affect motor performance and, in some cases, lead to motor failure. Solutions propsed in the art include vibration-resistant designs that incorporate features like lock washers, self-tightening nuts, or adhesive compounds can help prevent loosening; flexible connection mounts or damping materials for the connector block configured and arranged to absorb some of the vibration, thereby reducing its impact on the connectors; and using high-strength fasteners or connectors designed to resist loosening under vibration can improve reliability.

In direct-cooled e-motors, insulation breakdown is a common issue due to exposure to both high temperatures and coolant. Insulation degradation can lead to electrical faults, short circuits, and reduced efficiency. Over time, insulation materials may lose their effectiveness when exposed to high temperatures or coolants that degrade their properties. This breakdown can cause leakage currents, shorts, and ultimately reduce motor reliability. Proposed solutions include use of insulation materials rated for both high temperatures and chemical resistance, such as silicone-based or polymer insulations, that can help maintain integrity in harsh conditions; applying an additional layer of protective coating over the insulation that can shield it from direct exposure to coolant and extend its lifespan; and periodic testing of insulation resistance that can help detect early signs of degradation, allowing for proactive replacement or reinforcement.

Lastly, improper installation or maintenance of connector blocks can introduce a variety of problems, especially in direct-cooled systems. The complexity of the design, combined with coolant exposure, makes precise installation essential. If a connector block is not installed correctly or if maintenance is insufficient, issues like loose connections, poor sealing, and misalignment can arise. This not only affects performance but can also lead to early component failure. Here, solutions include designing connector blocks to be easily installed, with clear alignment features and simplified fastening mechanisms, that reduces the chance of error; while providing comprehensive guidelines, including torque specifications for fasteners and alignment instructions, that can aid technicians in proper installation; and establishing routine maintenance protocols, including inspections of coolant seals, electrical connections, and insulation, can extend the lifespan of the connector block.

Accordingly, connector blocks face numerous challenges to their effectiveness and longevity, while the proposed solutions, while carrying a degree of effectiveness, include their own challenges in terms of cost, engineering and manufacturing complexities, as well as design and implementation limitations. There is therefore a need in the art for connector blocks comprising a minimal number of components so as to reduce costs, while boasting a design that both seals and/or insulates the interior electrical connections from external influences as well as enables flexible and vibration resistance implementation. Additional protection against the deleterious effects of coolant or refrigerant present near and/or around the connector block is also needed in the art.

### BRIEF SUMMARY OF THE INVENTION

A first embodiment of the presently disclosed is directed to terminal housings or connector blocks (hereinafter referred to as connector blocks) having a housing that forms a cavity with a number of ingresses or access openings that are sealed against external elements while still allowing for passage of connectors, wire or wires, and the like therethrough into the cavity. By way of example, the number of ingresses may be two. The first ingress may be configured to accommodate a grommet or its alternatives, so as to form a mositure resistant or other such tight seal. The second ingress may include a seal placed therein to close it off. The seal may include two opposing surfaces, a first surface facing outward from the cavity and a second facing inwards. A steel plate may be arranged on and along the second surface.

A terminal may be arranged within the cavity, the terminal including a first opening or receiving element arranged proximate to and/or below the first ingress and at least one wire crimping element arranged proximate to the steel plate. The first opening is configured to receive a connector of some form that has passed through the grommet while the at least one wire crimping element is configured to crimp to a crimping end portion of a wire or group of wires that have passed through the steel plate and seal. The second ingress may include a number of slots forming individual passages through the second ingress. The number of slots may comprise walls running a length of the second ingress and spaced apart so as to form the individual slots. The walls may comprise fiberglass and the like. By way of design choice, number of slots is five with at least three slots configured and arranged to receive a wire or group of wires originating from the stator. The terminal may include an equivalent number of first openings to the number of first ingresses as well as an equivalent number of crimping elements to the number of slots. The terminal may be configured to receive, accommodate and otherwise form electrical connections with any number of inbound connectors, wire or wire groups, and the like.

In another embodiment, the grommet is configured to accommodate a feedthrough pin therethrough. Accordingly, the terminal first opening may also be configured to receive and form an electrical connection with the feedthrough pin.

In another embodiment, the grommets comprise synthetic rubber while the slots comprise fiberglass. In still another embodiment, epoxy or its known equivelants may be introduced within the cavity and/or in the slots along the second surface of the seal so as to hermetically seal the same and/or form a refrigerant compatible seal within the cavity and/or within the slots.

Another embodiment of the present invention includes at least two mounting eyelets arranged on the connector block housing configured and arranged to enable a flexible tollerance connection.

In yet another embodiment, the housing may comprise a unibody single block or multiple components held together via known connecting elements such as threaded bolts and mating nuts combinations. The block housing may comprise a material that is compatible with a refigerant and/or comprise high dielectric properties with at least 190 mega pascals of mechanical strength.

The above summary relates to many embodiments of the invention disclosed herein and is not intended to limit the scope of the invention, which is set forth in greater detail below as well as in the appended claims. These and other features of the present invention will be described in more detail below in the detailed description of the invention and in conjunction with the following figures.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope and spirit of the disclosure.

Various embodiments of the invention will be described in detail below, by way of example only, with reference to the accompanying drawings, of which:

FIG. 1A depicts an exterior of a typical direct cooled electric motor;

FIG. 1B depicts a view looking down on the top of the typical direct cooled electric motor of FIG. 1A;

FIG. 2 depicts a portion of the typical direct cooled electric motor with a connector block connected thereto;

FIG. 3A depicts an exploded view of a portion of a direct cooled electric motor according to a first embodiment of the present invention;

FIG. 3B depicts another exploded view of a direct cooled electric motor;

FIG. 4A depicts a magnified view of a stator and connector block according to a first embodiment of the present invention

FIG. 4B depicts a magnified and exploded view of a stator and connector block according to a first embodiment of the present invention

FIG. 5A depicts a typical stator without its housing;

FIG. 5B depicts the typical stator without its housing in electrical connection with a connector block according to a first embodiment of the present invention;

FIG. 6A depicts a first view of the typical stator with its housing, the typical stator being in the wired connection with the first connector block;

FIG. 6B depicts a different views of the typical stator with its housing, the typical stator being in the wired connection with the first connector block

FIG. 7 depicts a view of first connector block;

FIG. 8 depicts the first connector block cross section along line A-A of FIG. 3B;

FIG. 9A depicts a first view of another typical stator with its housing in electrical connection with a second connector block;

FIG. 9B depicts a second view of another typical stator with its housing in electrical connection with a second connector block;

FIG. 9C depicts a close up of the second connector block;

FIG. 10 depicts a cross section of the second connector block;

FIG. 11 depicts an exploded view of the second connector block; and

FIG. 12 depicts an exploded view of the second connector block with a bottom portion and top thereof.

### DETAILED DESCRIPTION OF THE INVENTION

The following embodiments are exemplary. Although the specification may refer to “an”, “one”, or “some” embodiment(s), this does not necessarily mean that each such reference is to the same embodiment(s), or that the feature only applies to a single embodiment. Features of different embodiments may be combined to provide further embodiments. Only elements relevant for illustrating the embodiments are described in detail. Details that are generally known to a person skilled in the art may not be specifically described herein.

Like elements are labeled with like reference numerals. For clarity and avoidance of repetition, duplicate elements are at times labeled only once. While the present invention is being described within the context of application to a direct cooled electric vehicle, the present invention is not strictly limited to the same and may be applied to other applications as envisioned by the skilled person, such other applications for example requiring and/or otherwise benefiting from sealed connector blocks as found in the present invention, including HVAC related applications.

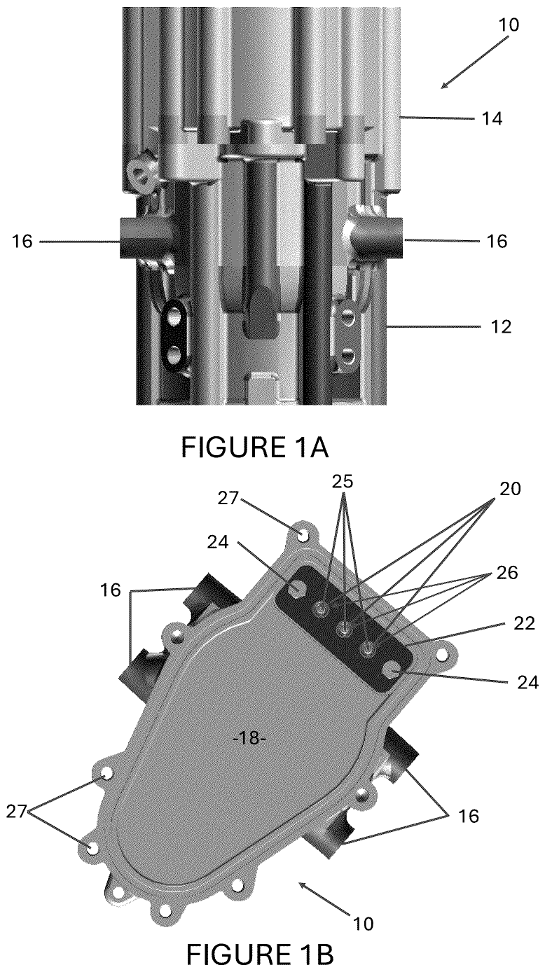

FIG. 1A depicts a close up of a portion of a typical direct cooled electronic motor 10 having a top portion 14 connected to a bottom portion 12 via a partition line. The bottom portion 12 may also be referred to as a motor housing or central housing. Both the top and bottom portions define internal openings.

Within the top portion sits an inverter that is powered by a stator sitting in the bottom portion. The bottom portion is directly cooled via coolant inlets or passages 16 passing into the bottom portion 12. As depicted in FIG. 1B, a top 18 of the bottom portion 12 also serves as a base of support for the top portion. The top and bottom portions may be bolted together as facilitated by a number of mounting eyelets 27 arranged along top 18. The top 18 includes three phase connectors 25 supported and otherwise held in place via plate 22 bolted to the top portion via bolts 24. The three phase connectors are accommodated in grommets 26 which in turn are accommodated in a first access opening 20 or first ingress of a connector block. As such a hermetic and/or high pressure refrigerant seal is formed between the bottom and top portions with respect to the first access opening 20. High pressure as used here is a term of art that can vary based on the refrigerant type and system design but is generally considered to be in the range of 300 to 400 psi or higher for high-pressure refrigerants like R-410A. For systems with lower-pressure refrigerants, such as R-134a, high pressure might range from 150 to 200 psi.

The phase connectors act as feedthrough pins which, in directly cooled electric motors, are conductive components that allow electrical connections to pass through a sealed barrier, such as the motor housing, without compromising cooling or insulation integrity. Such is essential considering the bottom portion is directly cooled. These pins are typically embedded in an insulated, sealed medium (like an epoxy or ceramic housing such as the grommets) to maintain electrical isolation while ensuring that coolant or contaminants do not enter the motor's internal components. Feedthrough pins facilitate a reliable connection between the motor windings and external power or control circuits, crucial for maintaining motor performance and durability.

The number of phase connectors is a matter of design choice. Equivalent substitutions for phase connectors include bus bars or metal strips or bars that conduct current across connections and may reduce the need for individual phase connectors; screw terminals that provide direct, secure connections for phase wires, commonly used in various motor setups; welded joints which may directly bond phase wires to the motor, though less flexible, offering durability and reliability; and crimp connectors that provide robust, vibration-resistant connections in place of traditional phase connectors. Each alternative provides electrical continuity, adapting to application-specific requirements in design and stability.

The number of first access openings 20 is a matter of design choice and are depicted here as being three. In each of the depicted first access openings 20 a grommet 25 is arranged for receiving a phase connector 26 therein. As is known in the art, in directly cooled electric motors, a grommet is a protective rubber or polymer ring placed where wires or cables pass through the motor's housing. Its primary purpose is to shield the cables from wear, abrasion, and potential damage caused by vibration or friction. Additionally, in cooling applications, grommets help maintain the motor's internal seal, preventing coolant from leaking into electrical compartments and ensuring safe, efficient operation. This protection helps extend the lifespan of both the motor and its wiring connections. Equivalent substitutions for grommets include bushings which offer protection for cables against abrasion and reduce wear in tight spaces; cable glands which form a seal around cables to provide strain relief and protection against dust, moisture, and vibration, ideal for robust environments; sealed pass-throughs that are often used for wires or tubes, these provide airtight or watertight seals to protect cables or fluids; and flexible conduits that surround cables and offer similar protection to grommets with added flexibility and resistance to damage. Each of the aforementioned helps to protect and insulate wiring in various environmental conditions, enhancing durability and performance.

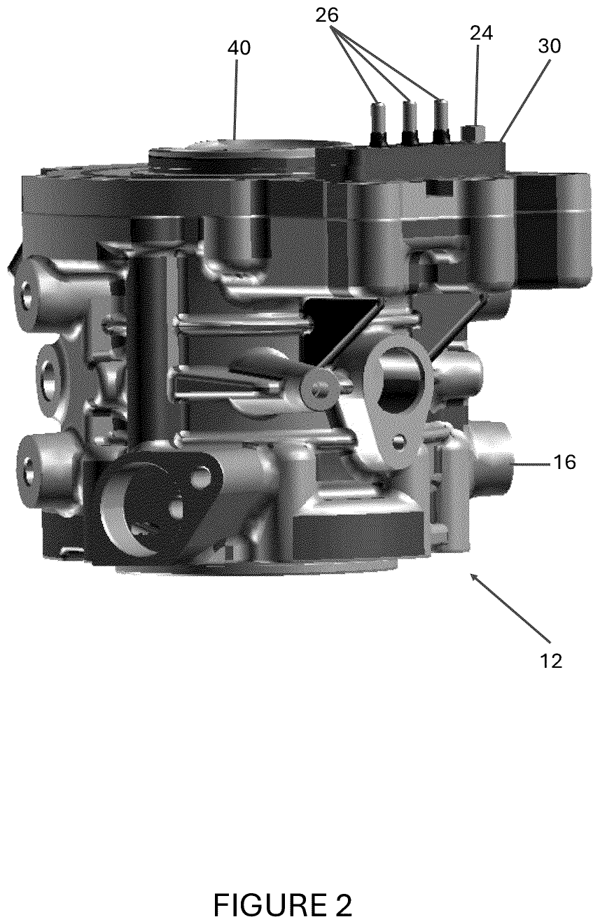

FIG. 2 depicts a perspective and side view of the bottom portion 12 without top 18 and with a first connector block 30 and a stator 40 at least partially accommodated within the body of the bottom portion. As depicted, the first connector block 30 includes the three first access openings 20 with phase connectors 26. The first connector block 30 is bolted onto the bottom portion 12 via a threaded bolt 24 which passes through a mounting eyelet of the connector block to connect with and otherwise be received by an appropriately located and configured threaded bolt receptacle (not depicted) within the bottom portion 12. A second threaded bolt, omitted from FIG. 2 for clarity, is also included on other side of first connector block 30. Equivelant substitutions for threaded bolts and receptacles combinations include snap-fit or clip mechanisms, rivets, welded joints and adhesive bonding.

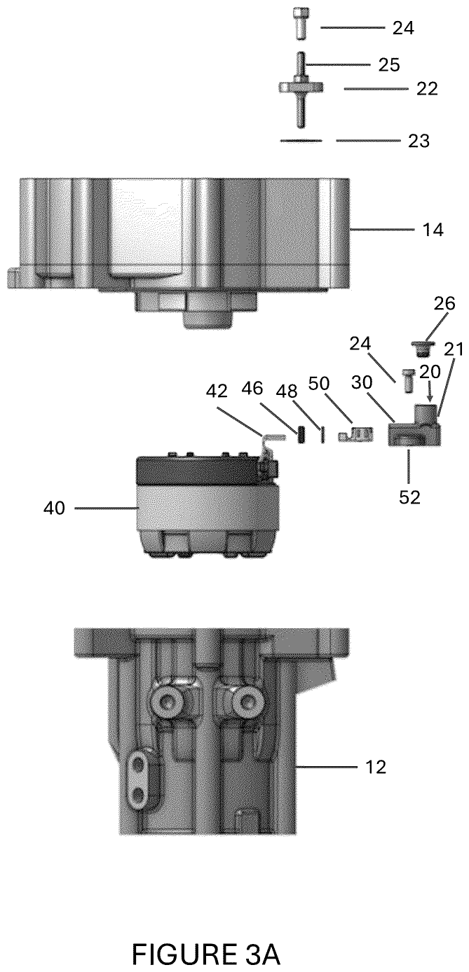

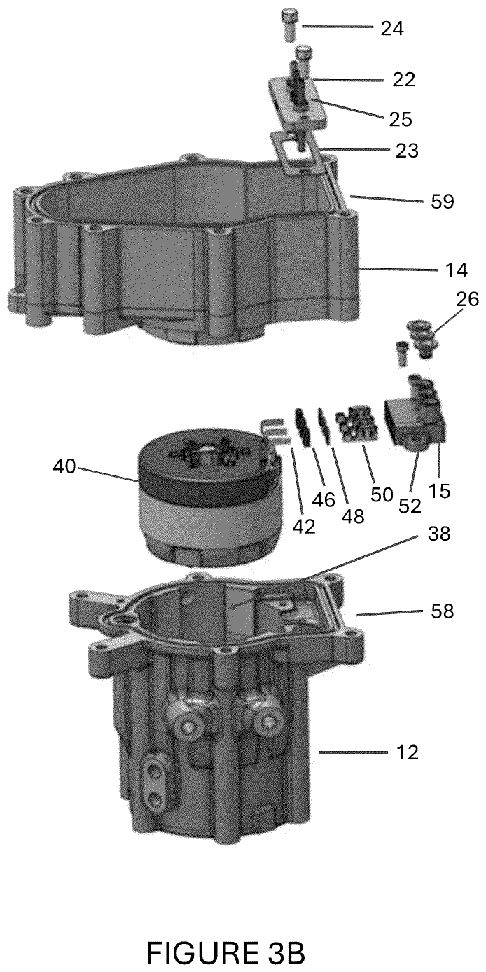

FIG. 3A depicts an exploded side view of the directly cooled electric motor including the top portion 14, the stator 40 and the bottom portion 12. The first connector block 30 comprises a unitary body defining an internal cavity. Housed within the cavity is a terminal 50, steel plate 48 and seal 46. The stator 40 includes a number of stator electrical pins 42 connected at a first end within the stator to wiring originating from, for example, the stator windings. Another end of the stator electrical pins 42 is configured and arranged to be received within the cavity after passing through a second access opening 60. The stator electrical pins 42 are received at the terminal 50 after passing through the seal 46 and steel plate 48, both of which are arranged on an outward facing side, with respect to cavity, of the terminal. The terminal is configured to receive and form an electrically conductive connection with the stator electrical pins 42. The seal 46 and steel plate 48 are configured and arranged within the second access opening 60 so as to maintain a seal that may be a hermetic and/or a high pressure refrigerant seal. The first connector block 30 includes mounting eyelet 52 through which bolt 24 may pass enroute to the threaded bolt receptacle (not depicted) within the bottom portion 12. Grommet 26 is depicted above the first access opening 20. Plate 22 of FIG. 1B is depicted above top portion 14 along with bolt 24 above the plate and gasket or seal 23 below the plate. When fastened together, the bolt 24 passes through bottom portion top 18 thereby securing the plate, above the gasket or seal, in place, while lining up the phase connector 25, grommets 26 and first access openings 20 as depicted in FIG. 1B. Accordingly, the phase connectors are now in position to electrically connect the stator 40 with an inverter or the like housed in the top portion 14. The first access openings 20 include a raised portion 21 formed as part of the unibody construction of the first connector block 30. The first raised portion 21 offers lateral stability to the grommet 26 inserted and friction fitted therebetween as well as the phase connecter inserted into the grommet.

FIG. 3B is a perspective view of the directly cooled electric motor depicted in FIG. 3A. In FIG. 3B, the opening 38 in the bottom portion 12 is visible as well as threaded bolt receptacles 58 to receive bolts and the like passing through appropriately configured and alighted bolt openings 59 in the top portion. Plate 22 is depicted in perspective form thereby revealing the two bolts 24 used to secure the plate 22 to top portion 18, gasket or seal 23 and the three phase connectors 25. This will line up the plate and the phase connectors in particular with their respective grommets, of which three are depicted in FIG. 3B. A single bolt 32 is depicted for clarity, though it will be appreciated from subsequent figures that first connector block 30 includes two mounting eyelets 52 each configured and arranged to accommodate a bolt therethrough. The first connector block 30 includes the second access opening 60 through which the three terminals, three steel plates and three seals pass so as to be accommodated within the first connector block; each of the terminals, steel plates and seals also arranged to receive the three inbound wire bundles respectively.

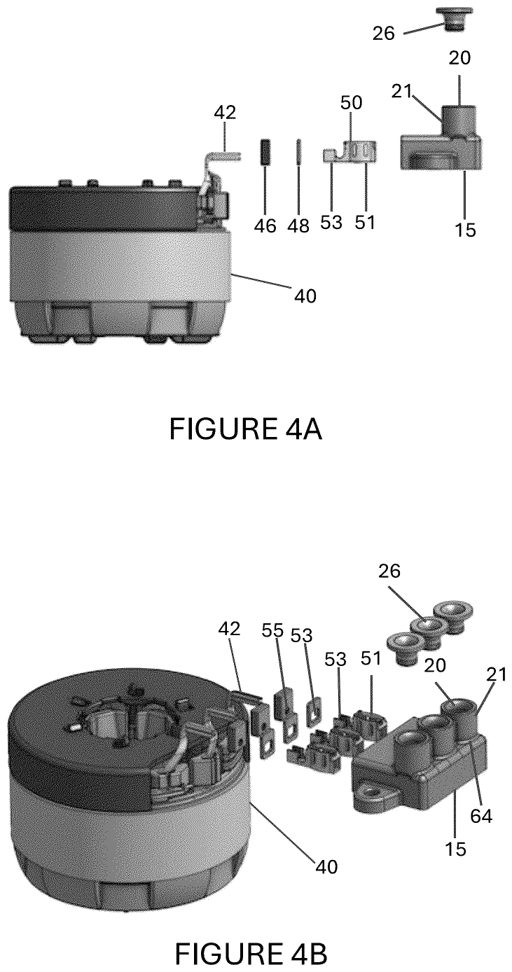

FIG. 4A depicts a magnification of a side view of the stator 40 with stator pins 42, seal 46, steel plate 48 and terminal 50 depicted in a line leading towards the first connector block 15. Grommet 26 is depicted above the first access opening 20. The terminal 50 comprises a first portion 51 located away from the stator 40 and a second portion 53 located proximate to the stator 40. When inserted into the cavity defined by the first connector block 15, the first portion 51 is arranged below the first access opening 20 such that a phase connector inserted through the grommet is received and accommodated in the first portion 51 which is further configured to make an electrically conductive connection with the phase connector. The second portion is configured to form a accommodate at least an end portion of stator pins 42 and form a crimping arrangement thereby providing an electrically conductive connection between terminal and stator pin. Accordingly, by virtue of the terminal 50, an electrical connection is formed, within the cavity of the first connector block between the stator pin and phase connector. Because the former is electrically connected to the stator and the latter electrically connected with the inverter, the terminal enable an electrical connection between stator and inverter within the relative safe confines of the first connector block cavity. This is facilitated by the first access opening and second access opening 60 being sealed off from its immediate environment through the presence and configuration of grommet 26 and 46. Being within the context of a directly cooled electric motor, the immediate environment includes coolant or refrigerant that is known to have deleterious effects on electrical connections. In addition to safety from such effect, the aforementioned terminal, first connector block arrangement offers a secured, mechanically connected and flexible connection thereby providing manufacturing and assembly advantages as would now be understood by the skilled person. FIG. 4B depicts FIG. 4A in perspective thus highlighting the arrangement (with only one of the three respective elements labeled for clarity) of three stator pins passing through openings (55 and 57 respectively) in three seals and steel plates of the second access opening 60 to an electrically conductive coupling with three terminals housed within the first connector block such that three phase connectors entering the first connector block via the three grommets and first access opening 20 are now in positions to form safe and secure connections with the stator pins, respectively. For stability and the like, side walls of the first access opening 20 include rings 64 about its base.

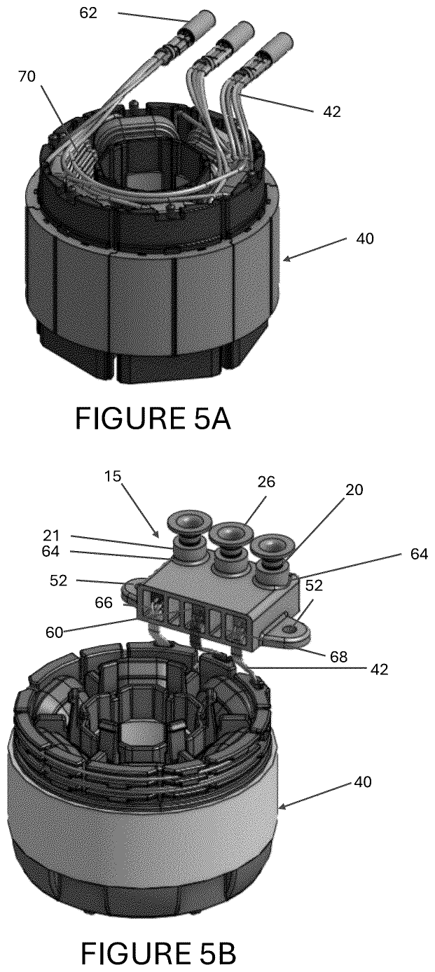

FIG. 5A depicts an interior of stator 40 showing three groups of wires 42 connected to windings 70 at one end and capped 62 at a distal end. FIG. 5B depicts stator 40 electrically connected to first connector block 15. The first connector block comprises a material capable of exhibiting 190 mega pascals of material strength. Known materials from which the first housing may be made include polyamide (nylon) composites, phenolic resins, high-strength plastics includes PEEK or polyetheretherketone, die-cast aluminum alloys and stainless steel. The second access opening 60 is depicted in a perspective format revealing that it runs the width of the first connector block 15 and may divided into slots 66 via introduction of walls 68 that run at least partially into the body of the first connector block. The number of walls and resulting slots is a matter of design choice provided access is facilitated for the wire groups to the terminal. As depicted in FIG. 5B, the number of walls is four thereby producing five slots, three of which host wire groups. The slots, from the seals in the direction outwards from the cavity may further include epoxy thereby further sealing the slot and the second access opening respectively thus sealing off the cavity from ingress via the second access slot but for the wire groups that pass through the epoxy, seal and steel plate. The epoxy further adds to the formation of a hermetical or high pressure refrigerant seal. A first and a partial view of a second mounting eyelet 52 is also depicted in FIG. 5B. The grommets 26 are fitted into first access openings 20 which include side walls 21 and rings 64.

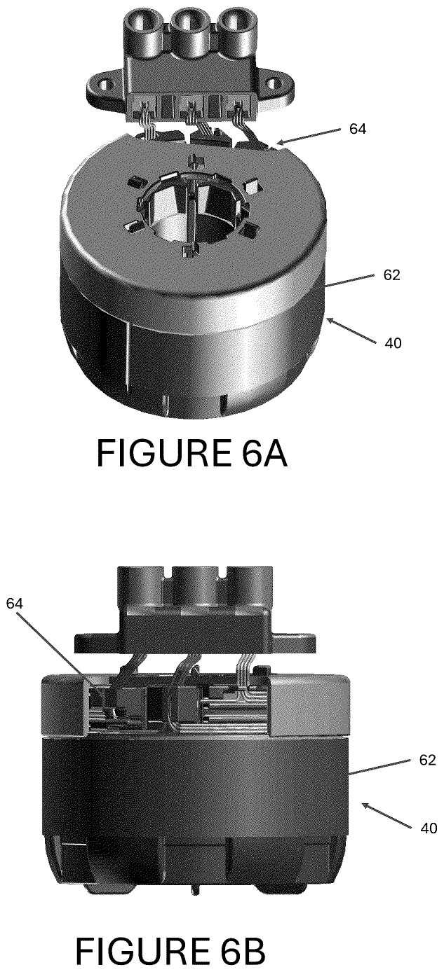

FIGS. 6A and 6B depict the stator 40 with a housing 62 in perspective view and a rear view respectively. As depicted, the housing surrounds the stator but for a rear portion 64 configured to allow passage of wires or groups of wires 42 from the stator 40 to the first connector block 15 for eventual electrical connection with the inverter.

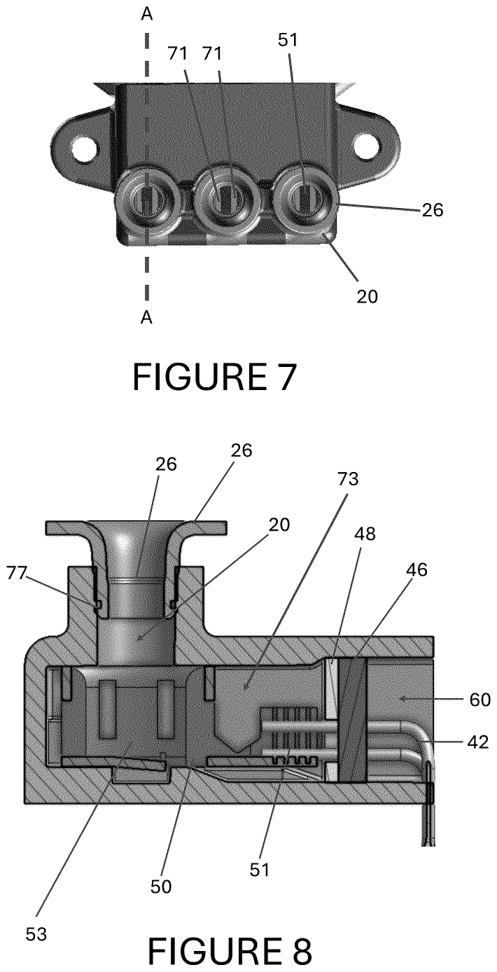

FIG. 7 depicts a top view of the first connector block 15 wherein an interior of the first access openings 20 with a portion of the first portion 51 of the terminal 50 visible through the first access openings. As shown, first portion 51 comprising opposing biasing elements 71 configured and arranged to receive at least a front end portion of a tip of a phase connector entering grommet 26 so as to make contact with the portion and establish an electrical connection therewith. The terminal may comprise any terminal known to the skilled person to establish the aforementioned accommodations and electrical connections.

FIG. 8 depicts a cross section of the connector block 15 along lines A-A from FIG. 7. As depicted, the connector block 15 comprises a unibody form or one piece defining a cavity 73, first access opening 20 and second access opening 60. Grommet 26 is inserted into the first access opening 20 and held in place by a combination of friction fit with internal walls of the first access opening, circumferential ribs 75 and slot arrangement 77 along an outer circumference of the grommet. Terminal 50 sits within cavity 73, the terminal including first portion 53 arranged below the grommet and first access opening and second portion 51 arranged proximate to the steel plate 48 and seal 46. Wires 42 are depicted entering the second access opening 60, passing through seal 46 and steel plate 48, and ending at the second portion 51 where they are physically connected and electrically coupled, via for example crimping, with the second portion 51. Cavity 73 may then be filled with epoxy, thereby further ensuring a hermetic, high pressure refrigerant and the like seal of the connector block. Epoxy may further be included in the second access opening between the seal 46 and entrance of the second access opening from outside the second connector block. Known equivelant substitutions for epoxy, within the context of the present invention, include silicone or polyurethane sealants, potting compounds, acrylic resins, thermal adhesives, and hot clue or polyamide. In another embodiment, the seals formed by at least one of the grommet, seal or epoxy filling, the combination of which form a high pressure refrigerant sealing and/or hermetic seal.

The wires 42 may be magnetic wires and or insulated with enamel. Magnetic wire, also known as magnet wire, is a type of insulated copper or aluminum wire used in applications that generate electromagnetic fields, such as transformers, motors, inductors, and electromagnets. Unlike regular wiring, magnetic wire is coated with a thin, heat-resistant insulation rather than thick plastic, allowing for tightly wound coils without short-circuiting. This enables efficient current flow to create magnetic fields, which are essential for energy conversion and signal generation in various electrical and electronic devices. Wires coated with enamel are known as enamel-coated or magnet wires. They are typically copper or aluminum conductors coated with a thin layer of enamel insulation. This insulation is heat-resistant and provides electrical insulation without adding significant thickness, allowing for tight winding and more turns in applications like transformers, motors, and inductors. Enamel-coated wires are key in creating magnetic fields for electromechanical functions because the thin insulation layer prevents short circuits while optimizing space within coils or windings.

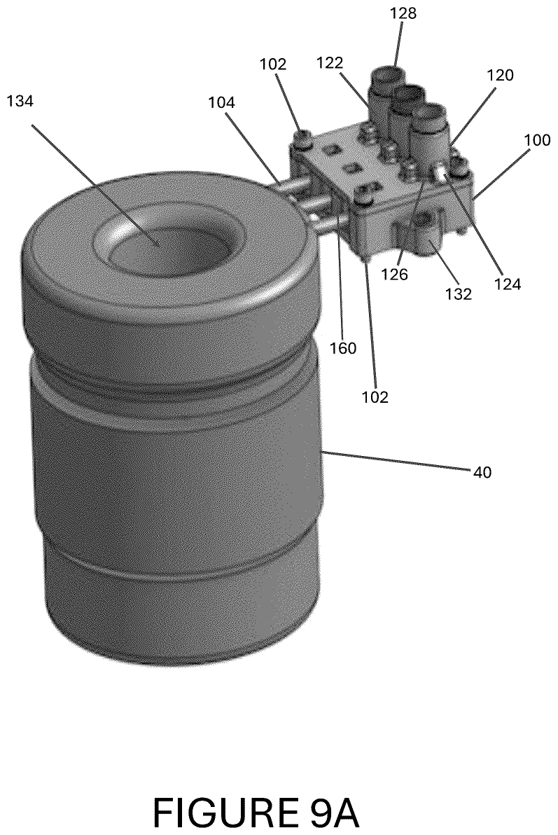

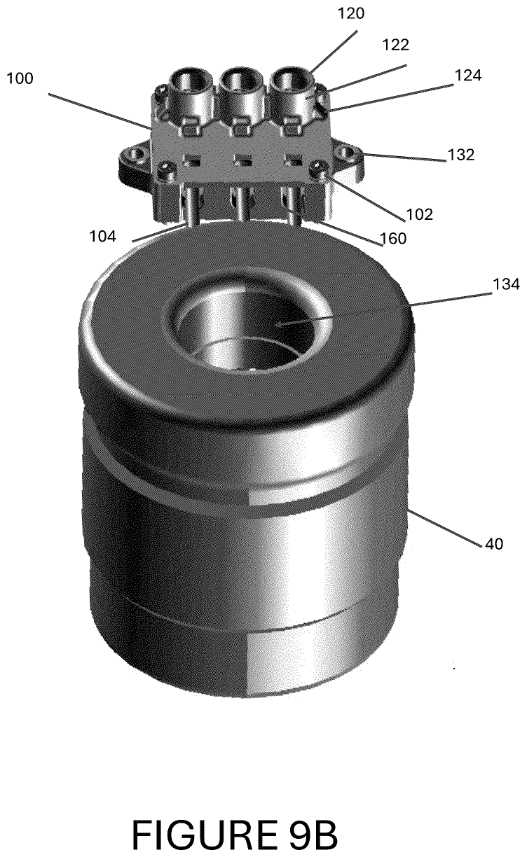

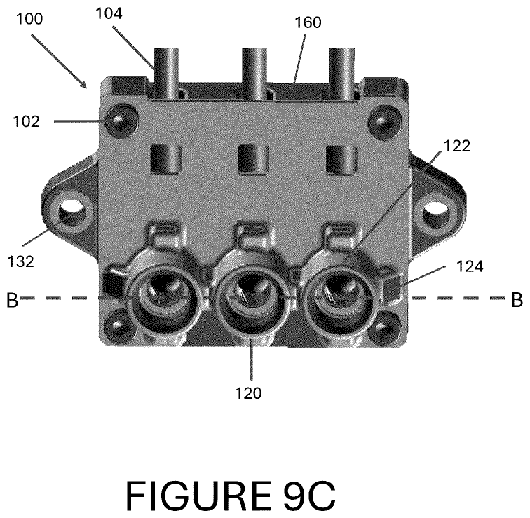

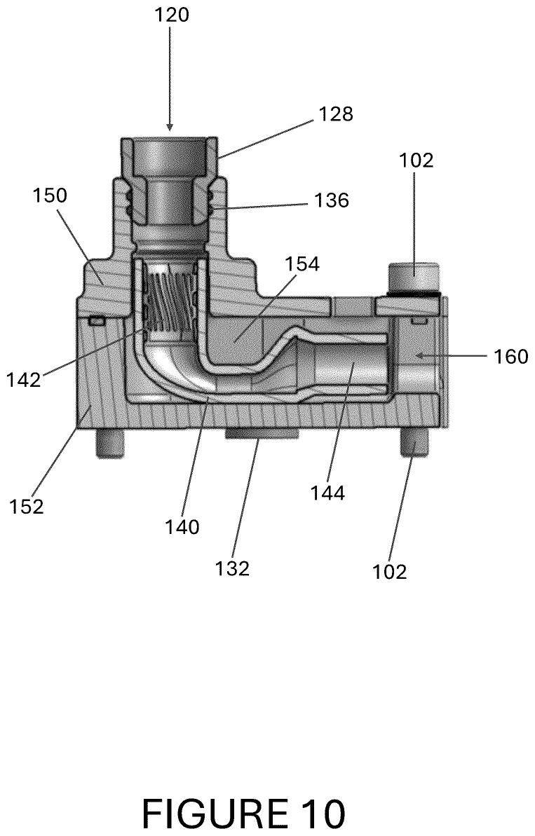

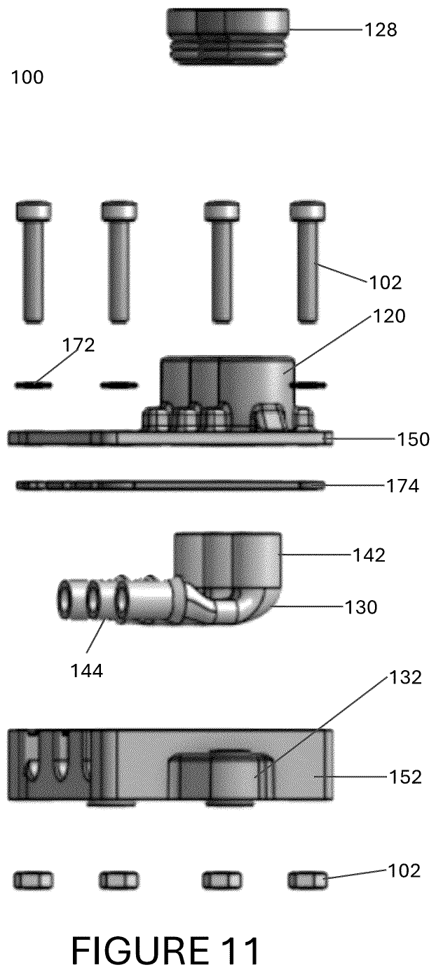

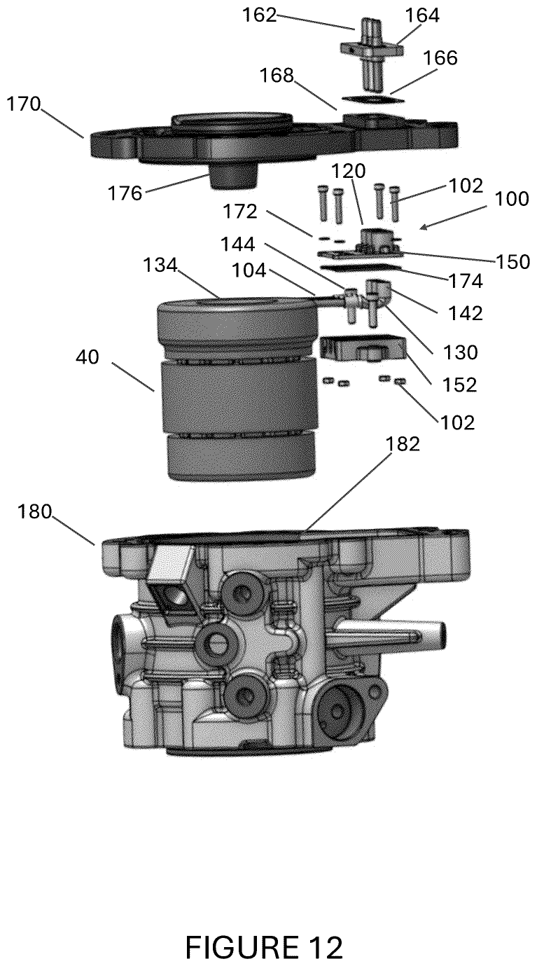

Another embodiment of the present invention is set out in FIGS. 9A-11D. FIGS. 9A and 9B depict different perspective views of stator 40 with a second connector block 100 and FIG. 9C depicts a close up of the second connector block 100. FIG. 10 depicts a cross section of the second stator block 100 along line B-B of FIG. 9C. FIG. 11 depicts an exploded view of the second stator block 100. FIG. 12 depicts an exploded view of teh second connector block in combination with a top and bottom portion of a direct cooled electic motor. Same reference numerals are used to depict same elements and repeated labeling of duplicate parts is avoided for ease of comprehension.

Starting with FIGS. 9A-9C, as depicted, second connector block 100 comprises multiple pieces mechanically held together via bolt and nut arrangements 102 located at approximately the four corners of the second connector block. As with the first connector block, with the second connector block three first access openings 120 are arranged along a top of the second connector block 100, the three including raised side walls 122, clips 124 and rings 126 (only one of each being labeled for ease of understanding) along the side wall base for lateral and generally structural support. A pair of mounting eyelets 132 are integrated and/or otherwise affexed to the body of the second connector block. As may be appreciated from FIG. 9A, the first access openings 120 are configured to receive grommets 128 which are in turn configured to receive various types of electrical connectors, including the aforementioned phase connectors (not shown here). Alterantively, as may be appreciated at least from FIGS. 9B and 9C, the first access openings 120 may be configured to receive connecting ends of connector plugs (not shown) therein, such plugs configured to plug into the first access openings and mate with an appropriately configured and arranged first portion of a terminal arranged within a cavity defined by the second connector block. As may be appreciated from FIGS. 9A and 9B, the stator 40 is depicted as having a long round shape with an top having a central opening 134. Electrical connections between stator and connector block may be effected via closed connectors 104 passing from the stator into the second connector block via second access openings 160, thereby enabling closed, safe and secure electrical connection between stator windings and terminal.

FIG. 10 depicts a cross section of the second connector block 100 along lines B-B of FIG. 9C. As depicted in FIG. 10, grommet 128 is friction fitted into the first access opening 120, the fricting fitting being enabled by a series of wedges 136 arranged along an inner wall of the first access opening. The fricting fitting may be enabled by any means known to the skilled person. The first access opening 120 leads to connector 140 which comprises a first receiving element 142 configured and arranged to receive an end of a connector plug (not shown) inserted into the first access opening 120 and grommet 128 and make electrical contact therewith. Located at another end of terminal 140 and proximate to the second access opening 160 is a second receiving element 144 of terminal 140, the second receiving element 144 configured and arranged to receive an end of closed connector 104 that was inserted into the second access opening 160 as depicted in FIGS. 9A-9C. The terminal 140 is configured and arranged to form and otherwise enable an electrical connection between the first and second openings and, in particular, the connector ends inserted therein. The second connector block 100 comprises a number of parts, namely first part 150 and second part 152, held together via the nut and bolt arrangement 102. The second connector block 100 and in particular the mating of the first and second parts 150, 152 define a cavity 154 that is configured and arranged to accommodate the terminal 140 along with the various connector ends inserted into the first and second access openings enroute to the terminal. Consistent with the first connector block 30, to ensure an effective seal, such as a hermetic or high pressure refrigerant seal or the like, the cavity and/or the portion between the second receiving element 144 and entrance to the second access opening 160 may be filled with epoxy. A bottom portion of eyelet 132 is also visible in FIG. 10.

FIG. 11 depicts an exploded view of the second connector 100 and FIG. 12 depicts an exploded view of the second connector 100 with top 170 and bottom portion 180. As shown, three phase connectors 162 are supported and otherwise held in place via plate 164. A gasket or seal 166 is arranged below the plate 164. The plate and gasket are arranged to bolt and/or otherwise affixed onto a particularly configured element 168 on a bottom portion 180 top 170, such affixing being enabled by means known to the skilled person. A portion of the second connector block 100 is arranged below the top 170 with at least the three first access openings 120 arranged to be accessible via and/or pass through the particularly configured element 168 so as to receive an end of the phase connectors 162. Mounting eyelets 132 are further depicted. Gromet 128 is depicted in FIG. 11, the grommet configured to be frictionally fitted into the first access opening 120.

The second connector block 100 is depicted in an exploded view. The second connector block includes the first portion or a top layer 150 on and through which the first access openings 120 sit and pass through. Washers 172 are placed in line with bolts and nuts combinations 120 which pass through openings located approximately at the corners of the top layer 150 and second portion or bottom layer 152, respectively, so as to affix and otherwise hold in place the top and bottom layers. Terminal 140 is arranged between the top and bottom layers 150, 152, the terminal including the first receiving element 142 configured to receive an end portion of phase connectors 162 and establish an electrical connection therewith. The terminal 130 further includes a second receiving element 144 configured to receive ends of connectors 104 whose other ends are electrically coupled to windings of the stator 40. A gasket 174 is also arranged between the top and bottom layers. Lastly, the top 170 includes an extension 176 configured and arranged to mechanically engage the center opening 134 in the stator 40 to aid in alignment and affixing of the top 170 to the bottom portion 180 while accommodating the stator 40 in a central opening 182 in the bottom portion.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the previous description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A connector block for a stator housing, comprising:
a housing forming an open cavity comprising a first access opening and a second access opening;
a grommet comprising a central opening, the grommet arranged in the first access opening to seal access into the cavity via the first access opening;
a seal comprising a first surface facing out from the cavity and a second surface facing into the cavity, the seal arranged in the second access opening to seal access into the cavity via the second access opening;
a steel plate arranged on the second surface;
a terminal arranged within the cavity, the terminal comprising a first opening and at least one wire crimping element, the first opening configured and arranged to be connected to via the central opening, and the at least one wire crimping element configured and arranged to receive an end portion of a wire,
wherein the seal and steel plate are configured to enable passage of a wire from outside the cavity to inside the cavity such that the end portion of the wire is received in the crimping element such that the wire is in electrical contact with the terminal.

2. The connector block according to claim 1, wherein the central opening of the grommet is configured to accommodate a feedthrough pin and the first opening of the terminal is configured to receive and connect with at least an end of the feedthrough pin such that the feedthrough pin is in electrical contact with the terminal and the wire.

3. The connector block according to claim 1, comprising three first access openings and wherein the second access opening comprises at least three slots.

4. The connector block according to claim 3, wherein the terminal comprises at least three electrically insulated wire crimping elements.

5. The connector block according to claim 4, wherein three of the at least three slots are configured and arranged to accommodate a wire therethrough such that the wire is connected at one end to the wire crimping element and the wire is connected at another end within the stator housing.

6. The connector block according to claim 5, wherein the seal and/or the grommet comprises a synthetic rubber and the at least three slots comprise fiberglass.

7. The connector block according to claim 1, wherein at least one of the cavity and the second access opening is sealed with a filling from upto outside of the second access opening upto the first surface of the seal.

8. The connector block according to claim 7, wherein the filling is an epoxy filling configured and arranged to hermetcially seal the second access opening.

9. The connector block according to claim 8, wherein the grommet and the epoxy filling form a high pressure refrigerant sealing.

10. The connector block according to claim 1, further comprising at least two eyes arranged connected to the housing, the at least two eyes configured to accommodate a connecting element therethrough such that the connecting element enables a flexible tolerance connection of the connector block to the stator housing.

11. The connector block according to claim 1, wherein the grommet is configured and arranged to compress and force fit into the first access opening.

12. The connector block according to claim 1, wherein the wire is magnetic wire and/or insulated with enamel.

13. The connector block according to claim 1, wherein the stator housing and the connector block are configured to operate in a direct cooled electric motor.

14. The connector block according to claim 13, wherein the first access opening is arranged proximate to the motor and the second access opening is arranged proximate to an inventer.

15. The connector block according to claim 1 comprising no bus bars.

16. The connector block according to claim 1, wherein the housing comprises high dielectric properties (values/units?) and at least 190 mega pascals of mechanical strength.

17. The connector block according to claim 1, wherein the housing comprises a material which is compatiable with refrigerant.

18. The connector block according to claim 1, wherein the at least one crimping element is configured to receive up to 15 mm of the end portion of the wire and to crimp to the end portion of the wire.
